(19) United States
(12) Patent Application Publication
(10) Pub. No.: US 2007/0229744 A1
(43) Pub. Date: Oct. 4, 2007

(54) VERTICALLY ALIGNED LIQUID CRYSTAL DISPLAY DEVICE

(75) Inventors: Minoru Yamaguchi, Tokyo (JP); Shinya Ando, Tokyo (JP); Ryota Mizusako, Sagamihara-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: CASIO COMPUTER CO., LTD., Tokyo (JP)

(21) Appl. No.: 11/692,635

(22) Filed: Mar. 28, 2007

(30) Foreign Application Priority Data
Mar. 29, 2006 (JP) 2006-091629

(51) Int. Cl. G02F 1/1337

(52) U.S. Cl. 349/129; 349/130

(57) ABSTRACT

A liquid crystal display device includes a pair of substrates, an opposing electrode formed by a conductive film provided on one of inner surfaces of the pair of substrates, a plurality of pixel electrodes formed by conductive films provided on the other one of the inner surfaces of the pair of substrates, a plurality of pixels being defined by those areas of the plurality of pixel electrodes which face the opposing electrode, vertical alignment films covering the inner surfaces of the pair of substrates, a liquid crystal layer having a negative dielectric anisotropy sealed between the pair of substrates, and cutaway portions each provided at least one of the pixel electrode and the opposing electrode and obtained by cutting away a part of the associated conductive film to define an alignment center of liquid crystal molecules in each pixel.

### BACKGROUND OF THE INVENTION

1. Field of the Invention

The present invention relates to a vertically aligned liquid crystal display device.

2. Description of the Related Art

A vertically aligned liquid crystal display device includes a pair of substrates facing each other with a predetermined gap provided therebetween, a plurality of pixel electrodes arrayed in a matrix form on one of the opposing inner surfaces of the pair of substrates, an opposing electrode provided on the inner surface of the other substrate, a plurality of pixels being defined by those areas of the plurality of pixel electrodes which face the opposing electrode, vertical alignment films respectively provided on the inner surfaces of the pair of substrates in such a way as to respectively cover the electrodes, and a liquid crystal layer having a negative dielectric anisotropy sealed between the pair of substrates.

The vertically aligned liquid crystal display device displays an image on a plurality of pixels including areas where the pixel electrodes face the opposing electrode by tilting the liquid crystal molecules from a vertically aligned state by applying a voltage between the electrodes. As disclosed in Japanese Patent No. 2565639, there is proposed a scheme of forming X-shaped slits in each pixel to align the liquid crystal molecules of each pixel so as to be tilted inward of the pixel from the peripheral portion of the pixel by the application of the voltage.

However, the X-shaped slits of the vertically aligned liquid crystal display device substantially lead to a reduction in the aperture ratio.

### SUMMARY OF THE INVENTION

Accordingly, it is an object of the present invention to provide a vertically aligned liquid crystal display device capable of stabilizing the aligned state of each pixel whose liquid crystal molecules are tilted with application of a voltage, thus ensuring the display of an image with a good quality.

To achieve the object, according to one aspect of the invention, there is provided a liquid crystal display device comprising:

a pair of substrates facing each other with a predetermined gap provided therebetween;

an opposing electrode formed by a conductive film on one of opposing inner surfaces of the pair of substrates;

a plurality of pixel electrodes formed by conductive films arrayed in a matrix form on an other one of the opposing inner surfaces of the pair of substrates, a plurality of pixels being defined by those areas of the plurality of pixel electrodes which face the opposing electrode;

vertical alignment films respectively provided on the inner surfaces of the pair of substrates in such a way as to respectively cover the opposing electrode and the pixel electrodes;

a liquid crystal layer having a negative dielectric anisotropy sealed between the pair of substrates; and

cutaway portions each provided, for each of the pixels, at least one of the pixel electrode and the opposing electrode and obtained by cutting away a part of the associated conductive film to define an alignment center of liquid crystal molecules in the each pixel.

According to the second aspect of the invention, there is provided a liquid crystal display device comprising:

a pair of substrates facing each other with a predetermined gap provided therebetween;

an opposing electrode formed by a conductive film on one of opposing inner surfaces of the pair of substrates;

a plurality of pixel electrodes formed by conductive films arrayed in a matrix form on an other one of the opposing inner surfaces of the pair of substrates, and having substantially a rectangular shape with short sides and long sides, and defined into a plurality of electrode portions having substantially a square shape by notched portions formed in parallel to the short sides in a lengthwise direction of the long sides, a plurality of pixels being defined by those areas of the plurality of pixel electrodes which face the opposing electrode;

vertical alignment films respectively provided on the inner surfaces of the pair of substrates in such a way as to respectively cover the opposing electrode and the pixel electrodes;

a liquid crystal layer having a negative dielectric anisotropy sealed between the pair of substrates; and

cutaway portions each provided, for each of the pixels, at the opposing electrode at positions corresponding to substantially center portions of a plurality of areas corresponding to the electrode portions of each of the pixel electrodes, and obtained by cutting away a part of the associated conductive film to define an alignment center of liquid crystal molecules in the each pixel.

According to the third aspect of the invention, there is provided a liquid crystal display device comprising:

a pair of substrates facing each other with a predetermined gap provided therebetween;

an opposing electrode formed by a conductive film on one of opposing inner surfaces of the pair of substrates;

a plurality of pixel electrodes formed by conductive films arrayed in a matrix form on an other one of the opposing inner surfaces of the pair of substrates, and having substantially a rectangular shape with short sides and long sides, a plurality of pixels being defined by those areas of the plurality of pixel electrodes which face the opposing electrode;

vertical alignment films respectively provided on the inner surfaces of the pair of substrates in such a way as to respectively cover the opposing electrode and the pixel electrodes;

a liquid crystal layer having a negative dielectric anisotropy sealed between the pair of substrates; and

cutaway portions each formed, for each of the pixels of the opposing electrode, into a rectangular shape whose short sides have substantially equal distances to respective edges of the rectangular pixel corresponding in shape to the pixel electrode.

The present invention can cause the liquid crystal molecules to tilt toward the center of each pixel to make the alignment states of the liquid crystal molecules uniform and stable.

### BRIEF DESCRIPTION OF THE DRAWINGS

These objects and other objects and advantages of the present invention will become more apparent upon reading of the following detailed description and the accompanying drawings in which:

FIG. 1 is a plan view showing a part of one of substrates of a liquid crystal display device according to a first embodiment of the present invention;

FIG. 2 is a cross-sectional view showing the cross section of the liquid crystal display device as shown in FIG. 1 along line II-II thereof;

FIG. 3 is a cross-sectional view showing the cross section of the liquid crystal display device as shown in FIG. 1 along line III-III thereof;

FIG. 4 is a plan view exemplarily showing the tilted states of the liquid crystal molecules of one pixel of the liquid crystal display device;

FIG. 5 is a cross-sectional view exemplarily showing the tilted states of the liquid crystal molecules of one pixel of the liquid crystal display device;

FIG. 6 is a plan view showing a part of one of substrates of a liquid crystal display device according to a second embodiment of the invention;

FIG. 7 is a plan view exemplarily showing the tilted states of the liquid crystal molecules of one pixel of the liquid crystal display device according to the second embodiment; and

FIG. 8 is a plan view showing a part of one of substrates of a liquid crystal display device according to a third embodiment of the invention.

### DETAILED DESCRIPTION OF THE PREFERRED EMBODIMENTS

### First Embodiment

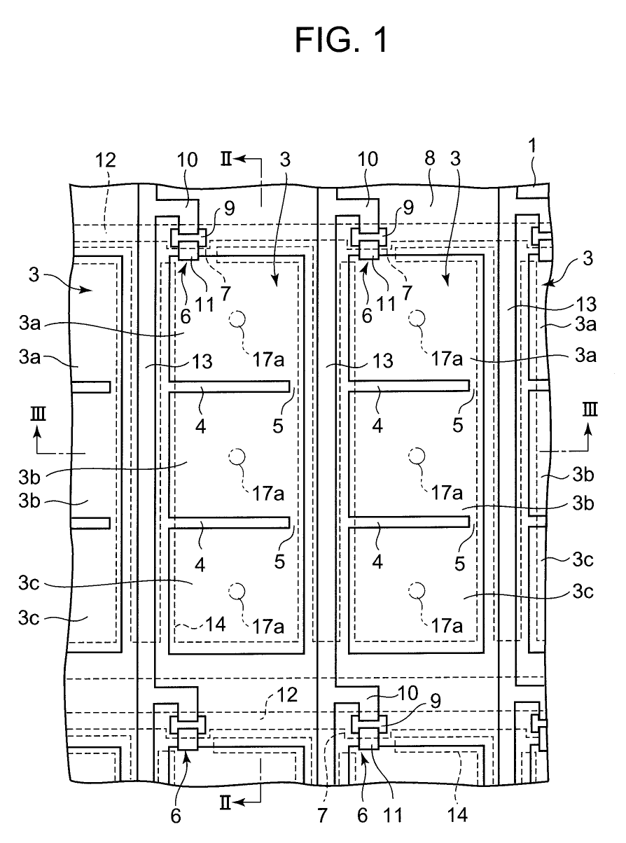

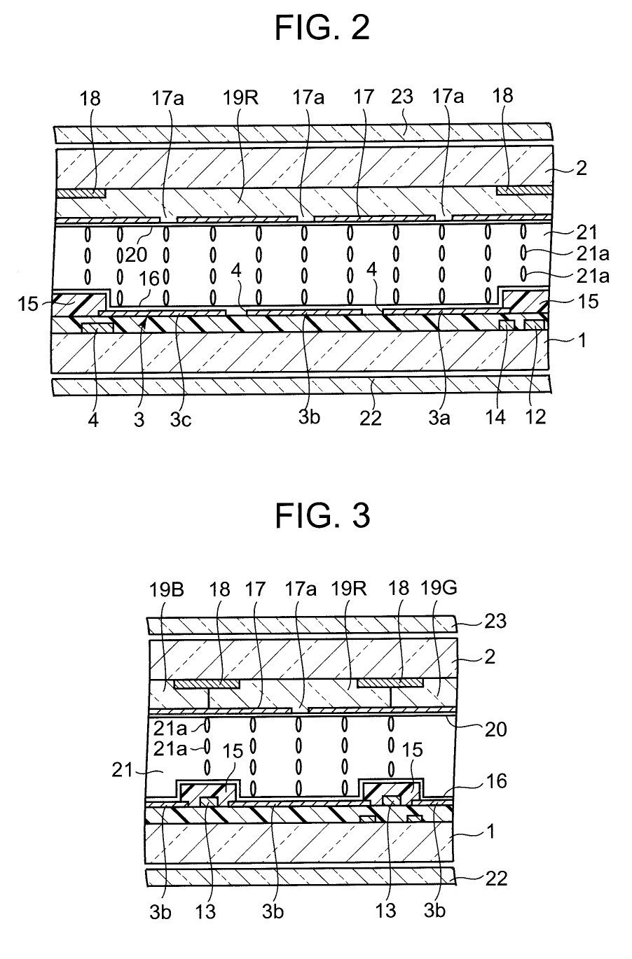

FIGS. 1 to 5 illustrate the first embodiment of the present invention. FIG. 1 is a plan view showing a part of one of substrates of a liquid crystal display device, FIGS. 2 and 3 are cross-sectional views of the liquid crystal display device along line II-II and line III-III.

The liquid crystal display device is a vertically aligned active matrix liquid crystal display device having TFTs (Thin Film Transistors) as active elements. As shown in FIGS. 1 to 3, the liquid crystal display device includes a pair of transparent substrates 1, 2 facing each other with a predetermined gap provided therebetween, vertical alignment films 16, 20 respectively provided on the inner surfaces of the pair of substrates 1, 2 in such a way as to respectively cover transparent pixel electrodes 3 and a transparent opposing electrode 17, and a liquid crystal layer 21 having a negative dielectric anisotropy sealed between the pair of substrates 1, 2. The transparent opposing electrode 17 is provided on one of the opposing inner surfaces of the pair of substrates 1, 2, e.g., the inner surface of one substrate or an observation-side substrate (hereinafter called “front substrate”) 2. Provided on the inner surface of the other substrate, e.g., the opposite substrate (hereinafter called “back substrate”) 1 to the display observation side pair of substrates are the transparent pixel electrodes 3 which are arrayed in a matrix form in the row direction (left and right direction in FIG. 1) and the column direction (up and down direction in FIG. 1) and define plurality of pixels at those areas which face the opposing electrode 17, a plurality of TFTs 6 provided on the inner surface of the back substrate 1 in association with the respective pixel electrodes 3 and connected to the respective pixel electrodes, and a plurality of scan lines 12 and signal lines 13 provided respectively along one side of the row of pixel electrodes and one side of the column of pixel electrodes for respectively supplying a gate signal and a data signal to the row of TFTs 6 and the column of TFTs 6.

Each of the TFTs 6 has a gate electrode 7 formed on the surface of the back substrate 1, a transparent gate insulation film 8 formed on the entire array area of the pixel electrodes 3, an i-type semiconductor film 9 formed opposite to the gate electrode 7 on the gate insulation film 8, and a drain electrode 10 and a source electrode 11 formed on one side portion and the other side portion of the i-type semiconductor film 9 via an n-type semiconductor film (not shown).

The scan lines 12 are formed integrally with the gate electrodes 7 of the TFTs 6 on the surface of the back substrate 1. The signal lines 13 are formed integrally with the drain electrodes 10 of the TFTs 6 on the gate insulation film 8. The pixel electrodes 3 are provided on the gate insulation film 8.

In the liquid crystal display device, each of the pixel electrodes 3 is formed in a vertically elongated rectangular shape the length of whose short side (horizontal width) in the row direction is smaller than the length of whose long side (vertical width) in the column direction, the short side being orthogonal to the long side.

In the embodiment, the length of the short side of each pixel electrode 3 (horizontal width) is set to approximately 50 μm, and the length of the long side thereof (vertical width) is set to approximately 150 μm. That is, the short side is set substantially an integer fraction of the long side, and is segmented into a plurality of electrode portions of an approximately square shape with each side of approximately 50 μm by notched portions formed in parallel to the short side in the lengthwise direction of the long side. In other words, the pixel electrodes 3 is formed by a transparent conductive film segmented into a plurality of electrode portions of an approximately square shape arranged with gaps therebetween in the lengthwise direction and connected together at a part of the edge portions of adjoining electrode portions with the gap therebetween.

The transparent conductive film is formed in a rectangular shape whose short side is set to about ⅓ of the long side, and is segmented into three electrode portions 3a, 3b, 3c of an approximately square shape by two notched portions (slits) 4 provided at two locations of the three lengthwise segments of the rectangular shape of the short side in parallel to the horizontal widthwise direction of the rectangular shape.

The shape of the electrode portions 3a, 3b, 3c may substantially be a square shape or a shape approximate to a square shape, and the desired vertical-to-horizontal size ratio is within 1:1±0.5, and preferably lies within 1±0.2. To be more specific, vertical-to-horizontal size ratio is set to an arbitrary ratio that ranges from 1:0.5 to 1:1.5. In this case, the respective vertical width and horizontal width are set such that where the vertical width is fixed at 1, the horizontal width take optimum values in the range of 0.5 to 1.5 respectively. More preferably, where the vertical width is fixed at 1, the horizontal width take optimum values in the range of 0.8 to 1.2 respectively. The slits 4 are so provided as to extend from one widthwise edge portion of the conductive film to near the other edge of the conductive film. The electrode portions 3a, 3b, 3c are connected together at link portions 5 formed between the other edge of the conductive film and the end portions of the slits 4.

The slits 4 are provided to have widths of approximately 3 to 5 μm, and the link portions 5 of the electrode portions 3a, 3b, 3c are formed as narrow as possible within the range in which the electric resistance does not exceed the allowable value.

Although the link portions 5 of the electrode portions 3a, 3b, 3c are formed on the same edge side of the conductive film in the embodiment, the link portions 5 of the adjoining two electrode portions 3a, 3b, 3c may be formed in such a way that the link portion 5 of one of the adjoining electrode portions may be formed on one edge side of the conductive film while the other link portion 5 of the electrode portions may be formed on the other edge side of the conductive film.

Further, the link portions 5 of the electrode portions 3a, 3b, 3c may be formed in the center portion of the conductive film by providing the slits 4 in such a way as to extend from both widthwise edge portions of the conductive film to near the center portion of the conductive film.

The TFT 6 is provided in correspondence to a part of one lengthwise edge of each pixel electrode 3 of the rectangular shape, and has the source electrode 11 connected to the electrode portion 3a on one edge side of the pixel electrode 3.

Further, compensation capacitive electrodes 14 are formed on the surface of the back substrate 1 in association with individual rows of pixel electrodes 3, each at the peripheral portion of the respective pixel electrode 3 excluding that portion to which the source electrode 11 of the TFT 6 of the respective pixel electrode 3 is connected. Each compensation capacitive electrode 14 faces another compensation capacitive electrode 14 via the gate insulation film 8, and forms a compensation capacitor with the gate insulation film 8 being a dielectric layer between the electrode 14 and the pixel electrode 3.

The sides of the compensation capacitive electrode 14 which correspond to the peripheral portion of the pixel electrode 3 are formed in such a way that the inner peripheral portion of each side of the pixel electrode 3 faces the peripheral portion of the pixel electrode 3 and the outer peripheral portion of that side has a width projects outward of the pixel electrode 3.

The compensation capacitive electrodes 14 corresponding to the respective rows of pixel electrodes 3 are connected together for each pixel electrode row on the opposite side to the TFT connection side of the pixel electrodes 3. Further, each row of compensation capacitive electrodes 14 is commonly connected to a capacitive electrode connection wiring(s) (not shown) provided in parallel to the signal lines 13 at one end or both ends of the pixel electrode 3 outside the array area thereof.

An overcoat insulation film 15 which covers the TFTs 6 and the signal lines 13 is provided on the inner surface of the back substrate 1 excluding that portion which corresponds to the pixel electrodes 3. The vertical alignment film 16 is formed over the overcoat insulation film 15.

Provided on the inner surface of the front substrate 2 are a lattice black mask 18 facing areas between a plurality of pixels formed by those areas where a plurality of pixel electrodes 3 provided on the inner surface of the back substrate 1 face the opposing electrode 17 provided on the inner surface of the front substrate 2, and color filters 19R, 19G, 19B of three colors of red, green and blue corresponding to the respective pixels. The opposing electrode 17 is formed over the color filters 19R, 19G, 19B, and the vertical alignment film 20 is formed over the opposing electrode 17.

In the liquid crystal display device, for each of the pixels, a cutaway portion 17a for defining the alignment center of the liquid crystal molecules in each pixel is provided at least one of the pixel electrode 3 and the opposing electrode 17, e.g., at the opposing electrode 17, at a predetermined portion in the pixel.

The cutaway portion 17a is formed in association with the center portion of each of a plurality of areas with an approximately square shape, which correspond to the electrode portions 3a, 3b, 3c of the pixel electrode 3 and form each rectangular pixel. The cutaway portion 17a has a hole with a circular planar shape. The diameter of the cutaway portion 17a is set to approximately 8 μm or greater, preferably 10 to 12 μm. In this case, it is preferable that the lengths of the individual sides of the rectangular pixel be equal to or less than approximately 50 μm.

The pair of substrates 1, 2 are connected together by a seal member (not shown) which surrounds the array area of the pixel electrodes 3, and a liquid crystal layer 21 having a thickness approximately 3.5 to 4.5 μm is sealed in the area between the substrates 1, 2 surrounded by the seal member.

As shown in FIGS. 2 and 3, the liquid crystal molecules, 21a, of the liquid crystal layer 21 are aligned substantially perpendicular to the surfaces of the substrates 1, 2 by the vertical orientation of the vertical alignment films 16, 20 respective provided on the inner surfaces of the pair of substrates 1, 2 so as to cover the pixel electrodes 3 and the opposing electrode 17.

Though not illustrated, the back substrate 1 has an extending portion protruding outward of the front substrate 2, at an end portion of the back substrate 1 in one or each of the row direction and the column direction, and the scan lines 12 and the signal lines 13 are respectively connected to a plurality of driver connection terminals formed at the extending portion(s), and the capacitive electrode connection wiring to which each row of compensation capacitive electrodes 14 are commonly connected are connected to terminals of a predetermined potential (e.g., the potential of the opposing electrode) formed at the extending portion(s).

Further, a cross electrode is formed at near a corner portion of the periphery of the back substrate 1 and is connected to the connection terminal formed at the extending portion(s) (which may be the same connection terminal of the capacitive electrode connection wiring(s) or another terminal having the same potential as that connection terminal). The opposing electrode provided on the inner surface of the front substrate 2 is connected to the cross electrode outside the portion where the substrates are connected by the seal member.

Polarizers 22, 23 are respectively laid out on the outer surfaces of the back substrate 1 and the front substrate 2 with their transmission axes being directed in a predetermined direction. In the embodiment, the polarizers 22, 23 are laid out with their transmission axes being substantially orthogonal to each other, so that the liquid crystal display device provides a normally-black mode display.

The liquid crystal display device displays an image by aligning the liquid crystal molecules 21a from the vertical alignment state to a tilted state with the voltage applied between the electrodes 3, 17 for each of a plurality of pixels constituted by areas where the pixel electrodes 3 face the opposing electrode 17.

That is, the liquid crystal molecules 21a of the liquid crystal layer 21 keep a vertically aligned state in the area between those pixels to which the voltage is not applied, and are so aligned as to be tilted toward the inside the pixels from the peripheral portion of the pixel by the application of the voltage between the electrodes 3, 17 in the pixels.

Further, as the coin slots 17a corresponding to predetermined portions in the plurality of pixels are provided at the opposing electrode 17 in the liquid crystal display device, the liquid crystal molecules 21a of the area that corresponds to the cutaway portion 17a of the opposing electrode 17 in the pixel keeps the vertically aligned state even when the voltage is applied between the electrodes 3, 17.

According to the liquid crystal display device, therefore, the liquid crystal molecules 21a of each pixel can be aligned so as to be tilted from the peripheral portion of the pixel to the predetermined portion in the pixel, i.e., toward the liquid crystal molecules 21a which keeps the vertically aligned state of the area corresponding to the cutaway portion 17a of the opposing electrode 17. This makes it possible to stably obtain the uniformly aligned state for each pixel area and thus display an image with a good quality.

Because each of the pixel electrodes 3 in the liquid crystal display device of the embodiment is formed into a vertically elongated rectangular shape whose short side in the row direction is shorter than the long side in the column direction, it is possible to increase the pixel density, thus ensuring display of a high-definition image.

In the embodiment, each of the pixel electrodes 3 is formed into a rectangular shape by the conductive film that is segmented into a plurality of electrode portions 3a, 3b, 3c of an approximately square shape by notched portions formed in parallel to the short sides in the lengthwise direction, and the hole-like cutaway portion 17a is provided in the center portion of each square-shaped area of the rectangular pixel constituted by a plurality of areas of an approximately square shape (hereinafter called “square-shaped areas”) corresponding to the electrode portions 3a, 3b, 3c of the pixel electrode 3. This makes it possible to tilt the liquid crystal molecules 21a of each pixel so that for each of the square-shaped areas, the liquid crystal molecules 21a are tilted from the peripheral portion of the square-shaped area toward the center of the area by the application of the voltage between the electrodes 3, 17.

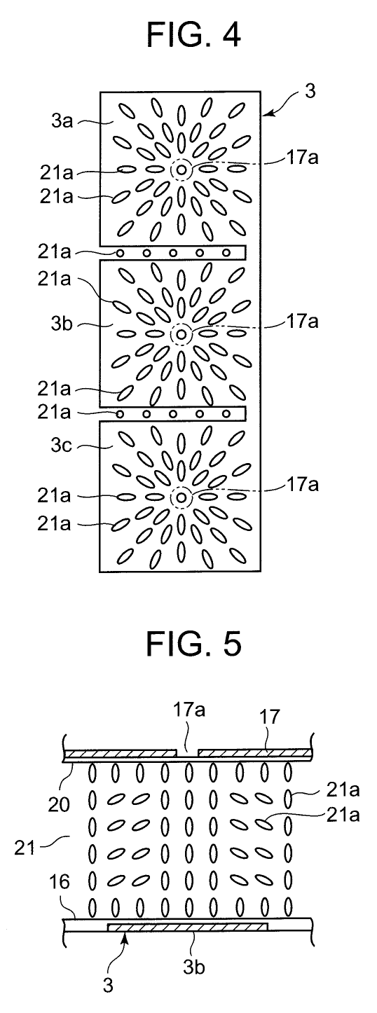

FIGS. 4 and 5 are a plan view and a cross-sectional view exemplarily showing the tilted states of the liquid crystal molecules 21a of one pixel of the liquid crystal display device.

As shown in FIGS. 4 and 5, at the center portion of each square-shaped area corresponding to each electrode portion 3a, 3b, 3c of the pixel electrode 3, i.e., at the portion corresponding to the hole-like cutaway portion 17a provided in the opposing electrode 17 and an area outside that each square-shaped area (area corresponding to the gap between the electrode portions 3a, 3b, 3c of the pixel electrode 3), the liquid crystal molecules 21a in the rectangular pixel are aligned so as to be tilted from the peripheral portion of each square-shaped area toward the center portion for each square-shaped area while keeping a vertically aligned state similar to the vertically aligned state of the liquid crystal molecules 21a of the area between the pixels.

Accordingly, the liquid crystal display device can stabilize the aligned state for each pixel and display an image with a good quality.

### Second Embodiment

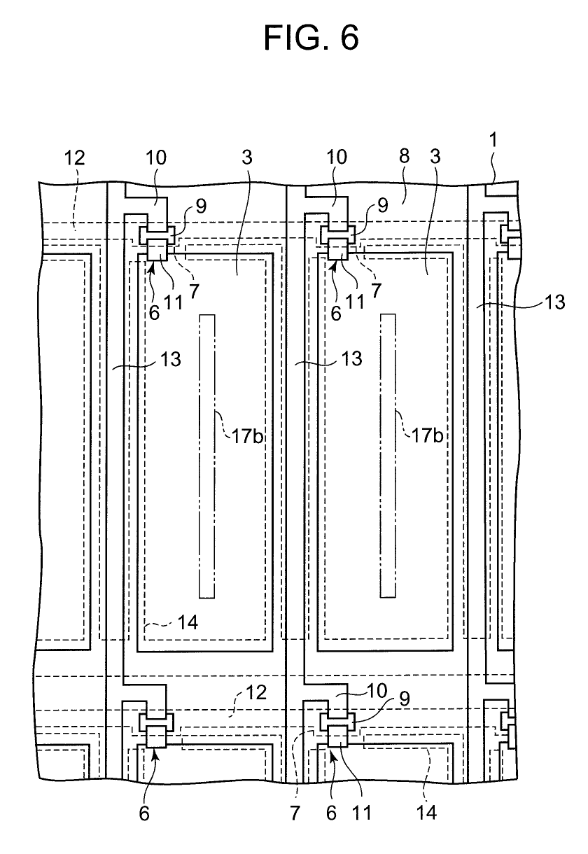

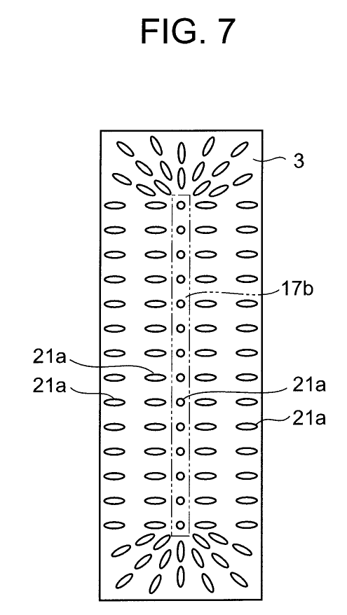

FIGS. 6 and 7 illustrate the second embodiment of the invention. FIG. 6 is a plan view of a part of one of the substrates of the liquid crystal display device, and FIG. 7 is a plan view exemplarily showing the tilted states of the liquid crystal molecules of one pixel of the liquid crystal display device. To avoid the redundant description, like or same reference numerals are given to those components of the second embodiment which are the same as the corresponding components of the first embodiment.

In the liquid crystal display device of the embodiment, a plurality of pixel electrodes 3 are formed by a transparent conductive film formed in a vertically elongated rectangular shape whose horizontal width (short side) in the row direction is smaller than the vertical width (long side) in the column direction in order to increase the pixel density and display a high-definition image. Slit-shaped cutaway portions 17b of lengths, which are substantially in parallel to the lengthwise direction of the pixel and have substantially equal distances to both lengthwise edges of the pixel in the direction toward inside the pixel, are provided at least one of the pixel electrode 3 and the opposing electrode 17 (see FIGS. 2 and 3), e.g., at the opposing electrode 17. The other configuration is the same as that of the liquid crystal display device of the first embodiment.

In the liquid crystal display device of the embodiment, the slit-shaped cutaway portion 17b is formed into a rectangular shape which have substantially equal distances to the sides of the rectangular shape from the edges of the rectangular pixel corresponding to the shape of the pixel electrode. The width of the slit-shaped cutaway portion 17b is set to approximately 8 μm or greater, preferably 10 to 12 μm. The cutaway portion 17b is formed in such a way that the distance from the edge of the cutaway portion 17b to the outer periphery of the pixel electrode 3 facing the opposing electrode 17 becomes 15 μm or less.

Further, it is preferable that the length of the slit-shaped cutaway portion 17b be set in such a way that the distances from both ends of the cutaway portion 17b to both edges of the pixel in the lengthwise direction become about equal to the distances between the widthwise peripheral edge of the pixel and the slit-shaped cutaway portion 17b.

According to the liquid crystal display device of the embodiment, the pixel electrodes 3 are each formed by a conductive film formed into a rectangular shape, and the slit-shaped cutaway portions 17b, which are substantially in parallel to the lengthwise direction of the pixel and have substantially equal distances to both lengthwise edges of the pixel in the direction toward inside the pixel, are provided in association with the widthwise center portion of the rectangular pixel corresponding to the shape of the pixel electrode 3 and at substantially equal distances toward inside the pixel from both lengthwise edges of the pixel. Accordingly, even when a voltage is applied between the electrodes 3, 17, the liquid crystal molecules 21a of the area corresponding to the slit-shaped cutaway portion 17b of the opposing electrode 17 in the pixel keep the vertically aligned state.

According to the liquid crystal display device, therefore, as shown in FIG. 7, the liquid crystal molecules 21a in each pixel can be aligned so as to be tilted from the peripheral portion of the pixel toward the area corresponding to the cutaway portion 17b in the widthwise center portion widthwise center portion of the pixel by the application of the voltage between the electrodes 3, 17, thus making it possible to stabilize the aligned state for each pixel and display of an image with a good quality.

As the cutaway portion 17b is formed in such a way that the distance from the periphery of the cutaway portion 17b to the outer periphery becomes 15 μm or less, abnormal alignment which occurs due to the disturbance of the alignment when the liquid crystal display device is deformed by the external force applied thereto can be restored to the normal aligned state after the deformation is restored to the original shape.

### Third Embodiment

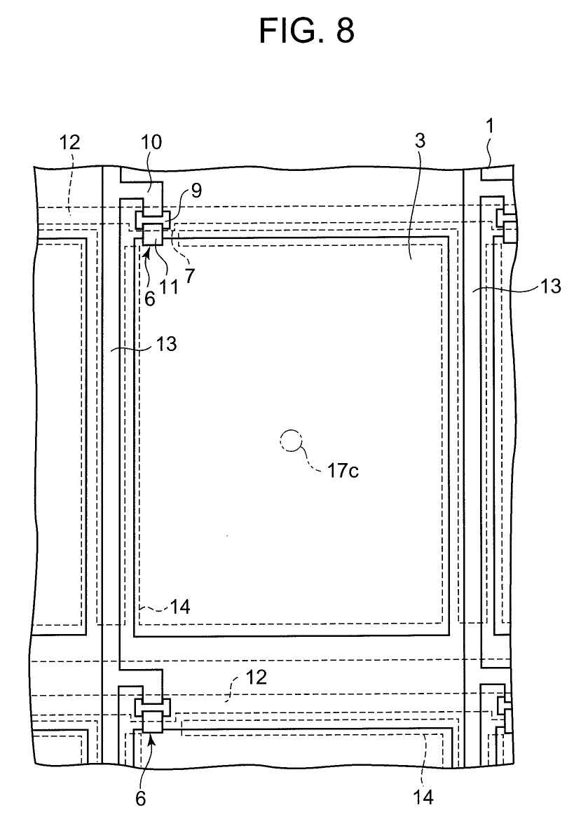

FIG. 8 is a plan view showing a part of one of the substrates of a liquid crystal display device according to the third embodiment of the invention. To avoid the redundant description, like or same reference numerals are given to those components of the third embodiment which are the same as the corresponding components of the first embodiment.

In the embodiment, a plurality of pixel electrodes 3 are each formed by a conductive film formed into an approximately square shape, and is applied to a liquid crystal display device which demands a relatively low-definition property. The shape of the electrode 3 may substantially be a square shape or a shape approximate to a square shape, and the desired vertical-to-horizontal size ratio is within 1:1±0.5, and preferably lies within 1±0.2.

In the embodiment, circular hole-like cutaway portions 17c having a diameter of approximately 8 μm or greater, preferably 10 to 12 μm are provided at least one of the pixel electrode 3 and the opposing electrode 17 (see FIGS. 2 and 3), e.g., at the opposing electrode 17, in association with the center portion of the pixel of an approximately square shape corresponding to the shape of the pixel electrode 3.

According to the liquid crystal display device of the embodiment, each of the pixel electrodes 3 is formed by a conductive film formed into an approximately square shape, and the hole-like cutaway portions 17c are provided at the opposing electrode 17, in association with the center portion of the pixel of an approximately square shape corresponding to the shape of the pixel electrode 3. This makes it possible to align the liquid crystal molecules of each pixel so as to be tilted from the peripheral portion of the pixel toward the center portion of the area pixel by the application of the voltage between the electrodes 3, 17.

### Other Embodiments

Although the cutaway portion 17a, 17b, 17c corresponding to a predetermined portion in a pixel is provided at the opposing electrode in the first to third embodiments, the cutaway portion 17a, 17b, 17c may be provided at the pixel electrode 3 or may be provided at both the pixel electrode 3 and the opposing electrode 17 in such a way as to face each other.

The liquid crystal display device according to one aspect of the present invention, as apparent from the above, includes a pair of substrates facing each other with a predetermined gap provided therebetween; an opposing electrode formed by a conductive film on one of opposing inner surfaces of the pair of substrates; a plurality of pixel electrodes formed by conductive films arrayed in a matrix form on an other one of the opposing inner surfaces of the pair of substrates, a plurality of pixels being defined by those areas of the plurality of pixel electrodes which face the opposing electrode; vertical alignment films respectively provided on the inner surfaces of the pair of substrates in such a way as to respectively cover the opposing electrode and the pixel electrodes; a liquid crystal layer having a negative dielectric anisotropy sealed between the pair of substrates; and cutaway portions each provided, for each of the pixels, at least one of the pixel electrode and the opposing electrode and obtained by cutting away a part of the associated conductive film to define an alignment center of liquid crystal molecules in the each pixel.

It is preferable that in the liquid crystal display device, the cutaway portions should be formed at the opposing electrode. It is preferable that the cutaway portions should be formed in a circular shape. In this case, it is desirable that the cutaway portions should be formed in a circular shape having a diameter of 8 μm or greater. It is desirable that the cutaway portions should be formed in a circular shape having a diameter of 8 μm or greater and 12 μm or less. It is further desirable that the cutaway portions should be formed in a circular shape having a diameter of substantially 10 μm or greater. It is further preferable that each of the pixel electrodes should be formed in a rectangular shape whose one side has a length of 50 μm or less, and the liquid crystal layer should have a thickness of 3.5 to 4.5 μm.

It is preferable that in the liquid crystal display device, the plurality of pixel electrodes should be formed by a conductive film having substantially a rectangular shape with short sides and long sides, and defined into a plurality of electrode portions having substantially a square shape by notched portions formed in parallel to the short sides in a lengthwise direction of the long sides, and each of the cutaway portions should be provided at least one of the electrode portions of each of the pixel electrodes and the opposing electrode in association with substantially center portions of a plurality of areas corresponding to the electrode portions of each of the pixel electrodes. It is also preferable that each of the pixel electrodes should be formed by a conductive film having a rectangular shape with short sides and long sides, and slit-shaped cutaway portions which are substantially in parallel to a lengthwise direction of the pixels and have lengths of substantially same distances from both lengthwise edges of the pixels in an inner direction thereof should be provided at least one of the pixel electrodes and the opposing electrode in association with widthwise center portions parallel to the short sides of the rectangular pixels corresponding in shape to the pixel electrodes.

It is preferable that in the liquid crystal display device, the pixel electrodes should be formed in substantially a square shape, and the cutaway portions should be formed substantially in centers of the respective pixels having substantially a square shape formed by the square pixel electrodes.

The liquid crystal display device according to the second aspect of the invention includes a pair of substrates facing each other with a predetermined gap provided therebetween; an opposing electrode formed by a conductive film on one of opposing inner surfaces of the pair of substrates; a plurality of pixel electrodes formed by conductive films arrayed in a matrix form on an other one of the opposing inner surfaces of the pair of substrates, and having substantially a rectangular shape with short sides and long sides, and defined into a plurality of electrode portions having substantially a square shape by notched portions formed in parallel to the short sides in a lengthwise direction of the long sides, a plurality of pixels being defined by those areas of the plurality of pixel electrodes which face the opposing electrode; vertical alignment films respectively provided on the inner surfaces of the pair of substrates in such a way as to respectively cover the opposing electrode and the pixel electrodes; a liquid crystal layer having a negative dielectric anisotropy sealed between the pair of substrates; and cutaway portions each provided, for each of the pixels, at the opposing electrode at positions corresponding to substantially center portions of a plurality of areas corresponding to the electrode portions of each of the pixel electrodes, and obtained by cutting away a part of the associated conductive film to define an alignment center of liquid crystal molecules in the each pixel.

It is preferable that in the liquid crystal display device, the cutaway portions should be formed in a circular shape having a diameter of 8 μm or greater and 12 μm or less. It is desirable that the cutaway portions should be formed in a circular shape having a diameter of substantially 10 μm or greater. It is preferable that lengths of short sides of the rectangular shape of the pixel electrode should be set equal to or less than 50 μm, and each of the electrode portions pixel electrodes should have substantially a square shape having one side of 50 μm. It is further preferable that the liquid crystal layer should have a thickness of 3.5 to 4.5 μm.

The liquid crystal display device according to the third aspect of the invention includes a pair of substrates facing each other with a predetermined gap provided therebetween; an opposing electrode formed by a conductive film on one of opposing inner surfaces of the pair of substrates; a plurality of pixel electrodes formed by conductive films arrayed in a matrix form on an other one of the opposing inner surfaces of the pair of substrates, and having substantially a rectangular shape with short sides and long sides, a plurality of pixels being defined by those areas of the plurality of pixel electrodes which face the opposing electrode; vertical alignment films respectively provided on the inner surfaces of the pair of substrates in such a way as to respectively cover the opposing electrode and the pixel electrodes; a liquid crystal layer having a negative dielectric anisotropy sealed between the pair of substrates; and cutaway portions each formed, for each of the pixels of the opposing electrode, into a rectangular shape whose short sides have substantially equal distances to respective edges of the rectangular pixel corresponding in shape to the pixel electrode.

It is preferable that in the liquid crystal display device, the cutaway portions should be formed in a slit shape having a width of 8 μm or greater in a short-side direction. It is preferable that each of the cutaway portions should be formed in such a shape that a distance in a short-side direction between one edge of a pixel defined by an area at which the pixel electrode faces the opposing electrode and one side of the cutaway portion which corresponds to the edge is equal to or less than 15 μm. In this case, it is preferable that lengths of short sides of the rectangular shape of the pixel electrode should be set equal to or less than 50 μm. It is desirable that the liquid crystal layer should have a thickness of 3.5 to 4.5 μm.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2006-91629 filed on Mar. 29, 2006 and including specification, claims, drawings and summary. The disclosure of the above Japanese Patent Application is incorporated herein by reference in its entirety.

What is claimed is:

1. A liquid crystal display device comprising:
a pair of substrates facing each other with a predetermined gap provided therebetween;
an opposing electrode formed by a conductive film on one of opposing inner surfaces of the pair of substrates;
a plurality of pixel electrodes formed by conductive films arrayed in a matrix form on an other one of the opposing inner surfaces of the pair of substrates, a plurality of pixels being defined by those areas of the plurality of pixel electrodes which face the opposing electrode;
vertical alignment films respectively provided on the inner surfaces of the pair of substrates in such a way as to respectively cover the opposing electrode and the pixel electrodes;
a liquid crystal layer having a negative dielectric anisotropy sealed between the pair of substrates; and
cutaway portions each provided, for each of the pixels, at least one of the pixel electrode and the opposing electrode and obtained by cutting away a part of the associated conductive film to define an alignment center of liquid crystal molecules in the each pixel.

2. The liquid crystal display device according to claim 1, wherein the cutaway portions are formed at the opposing electrode.

3. The liquid crystal display device according to claim 1, wherein the cutaway portions are formed in a circular shape.

4. The liquid crystal display device according to claim 3, wherein the cutaway portions are formed in a circular shape having a diameter of 8 μm or greater.

5. The liquid crystal display device according to claim 3, wherein the cutaway portions are formed in a circular shape having a diameter of 8 μm or greater and 12 μm or less.

6. The liquid crystal display device according to claim 3, wherein the cutaway portions are formed in a circular shape having a diameter of substantially 10 μm or greater.

7. The liquid crystal display device according to claim 4, wherein each of the pixel electrodes is formed in a rectangular shape whose one side has a length of 50 μm or less, and
the liquid crystal layer has a thickness of 3.5 to 4.5 μm.

8. The liquid crystal display device according to claim 1, wherein the plurality of pixel electrodes are formed by a conductive film having substantially a rectangular shape with short sides and long sides, and defined into a plurality of electrode portions having substantially a square shape by notched portions formed in parallel to the short sides in a lengthwise direction of the long sides, and
each of the cutaway portions is provided at least one of the electrode portions of each of the pixel electrodes and the opposing electrode in association with substantially center portions of a plurality of areas corresponding to the electrode portions of each of the pixel electrodes.

9. The liquid crystal display device according to claim 1, wherein each of the pixel electrodes is formed by a conductive film having a rectangular shape with short sides and long sides, and
slit-shaped cutaway portions which are substantially in parallel to a lengthwise direction of the pixels and have lengths of substantially same distances from both lengthwise edges of the pixels in an inner direction thereof are provided at least one of the pixel electrodes and the opposing electrode in association with widthwise center portions parallel to the short sides of the rectangular pixels corresponding in shape to the pixel electrodes.

10. The liquid crystal display device according to claim 1, wherein the pixel electrodes are formed in substantially a square shape, and
the cutaway portions are formed substantially in centers of the respective pixels having substantially a square shape formed by the square pixel electrodes.

11. A liquid crystal display device comprising:
a pair of substrates facing each other with a predetermined gap provided therebetween;
an opposing electrode formed by a conductive film on one of opposing inner surfaces of the pair of substrates;
a plurality of pixel electrodes formed by conductive films arrayed in a matrix form on an other one of the opposing inner surfaces of the pair of substrates, and having substantially a rectangular shape with short sides and long sides, and defined into a plurality of electrode portions having substantially a square shape by notched portions formed in parallel to the short sides in a lengthwise direction of the long sides, a plurality of pixels being defined by those areas of the plurality of pixel electrodes which face the opposing electrode;
vertical alignment films respectively provided on the inner surfaces of the pair of substrates in such a way as to respectively cover the opposing electrode and the pixel electrodes;
a liquid crystal layer having a negative dielectric anisotropy sealed between the pair of substrates; and
cutaway portions each provided, for each of the pixels, at the opposing electrode at positions corresponding to substantially center portions of a plurality of areas corresponding to the electrode portions of each of the pixel electrodes, and obtained by cutting away a part of the associated conductive film to define an alignment center of liquid crystal molecules in the each pixel.

12. The liquid crystal display device according to claim 11, wherein the cutaway portions are formed in a circular shape having a diameter of 8 μm or greater and 12 μm or less.

13. The liquid crystal display device according to claim 11, wherein the cutaway portions are formed in a circular shape having a diameter of substantially 10 μm or greater.

14. The liquid crystal display device according to claim 12, wherein lengths of short sides of the rectangular shape of the pixel electrode are set equal to or less than 50 μm, and each of the electrode portions pixel electrodes has substantially a square shape having one side of 50 μm.

15. The liquid crystal display device according to claim 12, wherein the liquid crystal layer has a thickness of 3.5 to 4.5 μm.

16. A liquid crystal display device comprising:
a pair of substrates facing each other with a predetermined gap provided therebetween;
an opposing electrode formed by a conductive film on one of opposing inner surfaces of the pair of substrates;
a plurality of pixel electrodes formed by conductive films arrayed in a matrix form on an other one of the opposing inner surfaces of the pair of substrates, and having substantially a rectangular shape with short sides and long sides, a plurality of pixels being defined by those areas of the plurality of pixel electrodes which face the opposing electrode;
vertical alignment films respectively provided on the inner surfaces of the pair of substrates in such a way as to respectively cover the opposing electrode and the pixel electrodes;
a liquid crystal layer having a negative dielectric anisotropy sealed between the pair of substrates; and
cutaway portions each formed, for each of the pixels of the opposing electrode, into a rectangular shape whose short sides have substantially equal distances to respective edges of the rectangular pixel corresponding in shape to the pixel electrode.

17. The liquid crystal display device according to claim 16, wherein the cutaway portions are formed in a slit shape having a width of 8 μm or greater in a short-side direction.

18. The liquid crystal display device according to claim 16, wherein each of the cutaway portions is formed in such a shape that a distance in a short-side direction between one edge of a pixel defined by an area at which the pixel electrode faces the opposing electrode and one side of the cutaway portion which corresponds to the edge is equal to or less than 15 μm.

19. The liquid crystal display device according to claim 18, wherein lengths of short sides of the rectangular shape of the pixel electrode are set equal to or less than 50 μm.

20. The liquid crystal display device according to claim 18, wherein the liquid crystal layer has a thickness of 3.5 to 4.5 μm.
